(19) United States
(12) Patent Application Publication
(10) Pub. No.: US 2026/0061368 A1
(43) Pub. Date: Mar. 5, 2026

(54) PURIFICATION SYSTEM

(71) Applicant: ISUZU MOTORS LIMITED, Yokohama-shi (JP)

(72) Inventors: Hisashi OZAWA, Fujisawa-shi (JP); Teppei OHORI, Fujisawa-shi (JP); Ryusuke FUJINO, Fujisawa-shi (JP)

(21) Appl. No.: 19/307,074

(22) Filed: Aug. 22, 2025

(30) Foreign Application Priority Data
Sep. 4, 2024 (JP) 2024-152457

(51) Int. Cl. B01D 53/86; B01D 53/26; B01D 69/08

(52) U.S. Cl. CPC B01D 53/864; B01D 53/266; B01D 69/08; B01D 2255/502

(57) ABSTRACT

A purification system has: a supply section that is provided in a line where a to-be-purified gas containing methane and oxygen flows, and supplies ozone to the to-be-purified gas by generating the ozone from the oxygen contained in the gas; a compressing section that is provided downstream of the supply section in the line, and adiabatically compresses the to-be-purified gas supplied with the ozone; and a catalyst that is provided downstream of the compressing section in the line, and purifies the methane in the to-be-purified gas under an ozone atmosphere, in which the compressing section raises temperature of the to-be-purified gas by adiabatically compressing the to-be-purified gas.

### CROSS-REFERENCE TO RELATED APPLICATIONS

The present application claims priority to Japanese Patent Applications No. 2024-130624, filed on Aug. 7, 2024, contents of which are incorporated herein by reference in their entirety.

### BACKGROUND OF THE INVENTION

The present invention relates to a purification system that purifies pollutants. There is a known catalyst that decomposes pollutants under an ozone atmosphere. WO 2013/042644 discloses a technology to purify a gas containing pollutants and ozone generated from compressed air obtained after compressing air with a compressor, by bringing the gas into contact with a catalyst.

Meanwhile, it becomes easier for methane and ozone to react on a catalyst, and the purification rate is enhanced as the temperature of a gas containing ozone and pollutants increases. However, it becomes more difficult to generate ozone as the temperature of generation-source air increases. Accordingly, if ozone is generated using compressed air whose temperature has been increased by being compressed by a compressor, the generation amount of ozone decreases undesirably as compared to a case where ozone is generated from air at a low temperature. As a result, ozone to be in contact with a catalyst decreases. Accordingly, it has been not possible to purify pollutants, resulting in lower pollutant purification rates.

### BRIEF SUMMARY OF THE INVENTION

The present invention has been made in view of these matters, and an object thereof is to enhance the pollutant purification rate.

An aspect of the present invention provides a purification system having: a supply section that is provided in a line where a gas containing methane and oxygen flows, and supplies ozone to the gas by generating the ozone from the oxygen contained in the gas; a compressing section that is provided downstream of the supply section in the line, and adiabatically compresses the gas supplied with the ozone; and a catalyst that is provided downstream of the compressing section in the line, and purifies the methane in the gas under an ozone atmosphere, in which the compressing section raises temperature of the gas by adiabatically compressing the gas.

### BRIEF DESCRIPTION OF THE DRAWINGS

FIG. 1 is a drawing for explaining the configuration of a purification system.

FIG. 2 is a drawing for explaining a removing section.

FIG. 3 is a drawing for explaining a methane purification rate.

FIG. 4 is a flowchart depicting an example of a methane purification process.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### <Configuration of Purification System S>

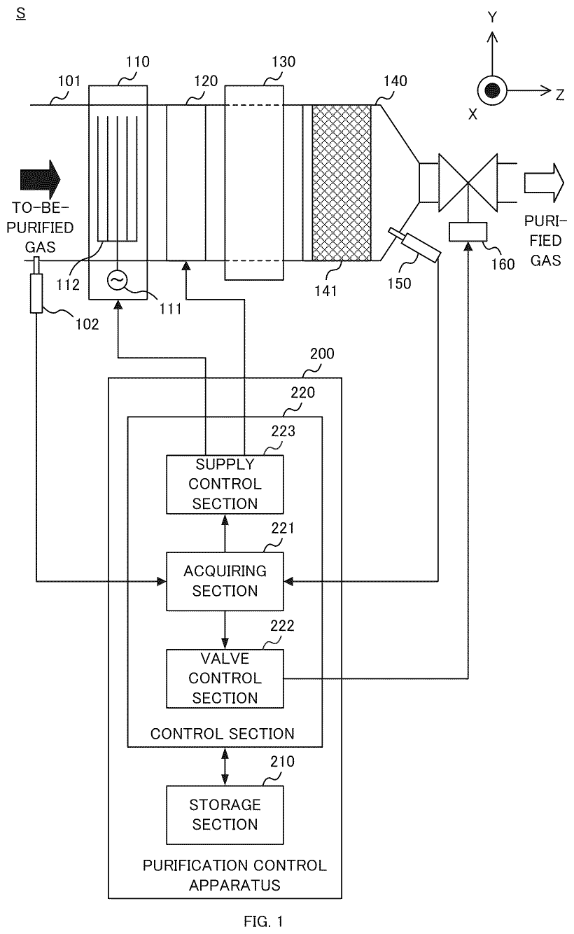

FIG. 1 is a drawing for explaining the configuration of a purification system S. The purification system S has a line 101, a methane sensor 102, a supply section 110, a compressing section 120, a removing section 130, a decomposing section 140, a catalyst 141, a temperature sensor 150, a control valve 160, and a purification control apparatus 200. The purification system S decomposes methane to generate water and nitrogen dioxide by adding ozone to a gas containing methane and causing ozone and methane to react on a catalyst. In the following explanation, decomposing methane to generate water and nitrogen dioxide is referred to as purifying methane in some cases.

A to-be-purified gas containing methane, which is an air pollutant that exhibits greenhouse effect properties, flows through the line 101. For example, the to-be-purified gas containing methane is atmospheric air containing oxygen. The methane sensor 102 is provided in the line 101. The methane sensor 102 senses the amount of methane in the to-be-purified gas at predetermined time intervals. For example, the predetermined time intervals are 100 milliseconds, but are not limited to this. For example, the methane sensor 102 senses the methane concentration of the to-be-purified gas as the amount of methane. Each time the methane sensor 102 senses the methane concentration, the methane sensor 102 outputs the sensed methane concentration to the purification control apparatus 200.

The supply section 110 is provided downstream of the methane sensor 102 in the line 101. The supply section 110 supplies ozone to the to-be-purified gas by generating ozone from oxygen contained in the to-be-purified gas. For example, the supply section 110 has an AC power supply 111 and electrodes 112 covered with a dielectric such as glass.

The AC power supply 111 applies an AC voltage to the electrodes 112. For example, the AC power supply 111 applies, to the electrodes 112, an AC voltage that can cause discharge at the electrodes 112. Specifically, the AC power supply 111 applies, to the electrodes 112, an AC voltage which is equal to or greater than 1 kV and equal to or greater than 1 kHz. More specifically, in a case where silent discharge is caused between the electrodes 112, the AC power supply 111 applies, to the electrodes 112, an AC voltage whose voltage is equal to or greater than 10 kV and whose frequency is equal to or greater than 1 kHz and equal to or lower than 100 kHz. In addition, in a case where creeping discharge is caused on the surfaces of the electrodes 112, the AC power supply 111 applies, to the electrodes 112, an AC voltage whose voltage is equal to or greater than 1 kV and equal to or lower than 10 kV and whose frequency is equal to or greater than 1 kHz and equal to or lower than 10 KHz.

In a case where discharge is caused at the electrodes 112, electrons generated by discharge collide with oxygen molecules contained in the to-be-purified gas flowing between and around the electrodes 112. Each oxygen molecule that is collided with by an electron dissociates into two oxygen atoms. Then, ozone is generated through the combination of an oxygen atom with an oxygen molecule. In this manner, the supply section 110 supplies ozone generated by discharge to the to-be-purified gas flow between and around the electrodes 112.

The supply section 110 may generate ozone by emitting ultraviolet rays onto the to-be-purified gas. In this case, the supply section 110 has an ultraviolet lamp. When an ultraviolet ray emitted from the ultraviolet lamp collides with one oxygen molecule contained in the to-be-purified gas, the one oxygen molecule dissociates into two oxygen atoms. Then, ozone is generated through the combination of an oxygen atom with an oxygen molecule.

The compressing section 120 is provided downstream of the supply section 110 in the line 101. The compressing section 120 is a compressor that adiabatically compresses a gas, and, for example, is a scroll-type compressor or a screw-type compressor, but is not limited to these. The compressor desirably can change the amount of a gas to be drawn in or discharged by changing its rotation speed.

The compressing section 120 draws in the to-be-purified gas supplied with ozone, and adiabatically compresses the to-be-purified gas drawn in. By adiabatically compressing the to-be-purified gas, the compressing section 120 makes the pressure of the to-be-purified gas higher than the pressure of the to-be-purified gas (atmospheric air) before being drawn in. The compressing section 120 can raise the temperature of the to-be-purified gas by adiabatically compressing the to-be-purified gas and raising the pressure of the to-be-purified gas.

Meanwhile, the generation amount of ozone is greater in a case where ozone is generate from a gas at a lower temperature than in a case where ozone is generated from a gas at a higher temperature. As described above, the purification system S adiabatically compresses the to-be-purified gas supplied with ozone. That is, the purification system S generates ozone from the to-be-purified gas at a lower temperature before being adiabatically compressed. Accordingly, the purification system S can increase the generation amount of ozone as compared to a case where ozone is generated using compressed air at a higher temperature.

The compressing section 120 delivers the to-be-purified gas whose temperature has been raised by the adiabatic compression to the downstream side of the compressing section 120 in the line 101. In the following explanation, the adiabatically compressed to-be-purified gas is referred to as a compressed gas in some cases.

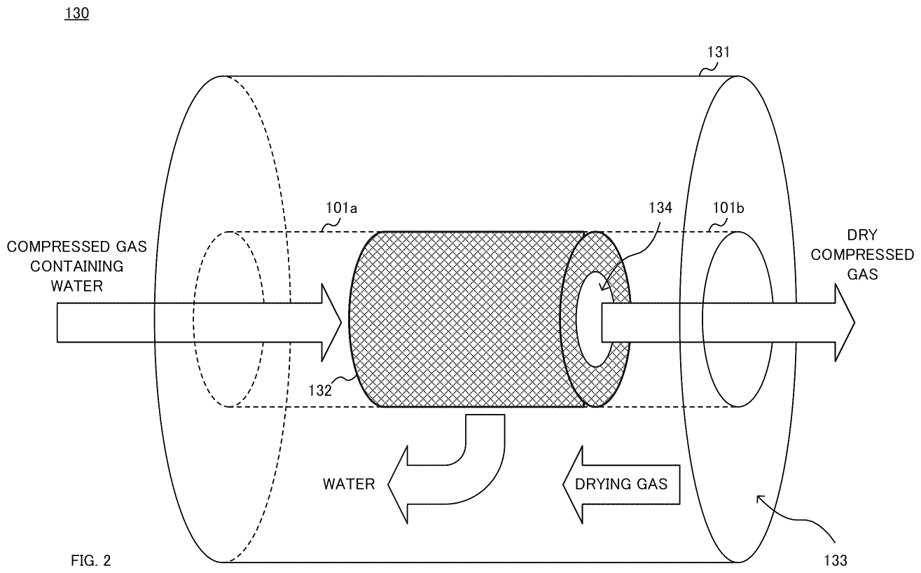

The removing section 130 is provided downstream of the compressing section 120 in the line 101. The removing section 130 removes at least partial water of water contained in the compressed gas. FIG. 2 is a drawing for explaining the removing section 130. The removing section 130 has a housing 131 and a hollow fiber membrane 132 through which water can be transmitted.

The housing 131 is penetrated by the line 101. In other words, the housing 131 encloses the line 101. The hollow fiber membrane 132 is provided in the housing 131. The hollow fiber membrane 132 is provided in the housing 131 with a gap 133 between the hollow fiber membrane 132 and the wall of the housing 131. A drying gas flows through the gap 133. For example, the drying gas is air from which water has been removed in advance. The drying gas is not necessarily air from which water has been removed, but only has to be a gas not containing water. For example, the drying gas is dry nitrogen.

The hollow fiber membrane 132 connected with the line 101 at both ends. In other words, the hollow fiber membrane 132 is connected to a line 101a positioned upstream of the hollow fiber membrane 132 and a line 101b positioned downstream of the hollow fiber membrane 132. The hollow fiber membrane 132 is exposed to the gap 133.

The hollow fiber membrane 132 has a cylindrical shape having a through-hole 134 penetrating in the axial direction of the hollow fiber membrane 132. The compressed gas containing water passes through the through-hole 134. The hollow fiber membrane 132 discharges at least partial water of water contained in the compressed gas containing water to the outside of the hollow fiber membrane 132. Specifically, when the compressed gas having pressure higher than the drying gas flowing outside the hollow fiber membrane 132 flows through the through-hole 134 inside the hollow fiber membrane 132, the hollow fiber membrane 132 discharges the partial water of the compressed gas to the drying gas flowing through the gap 133. In this manner, water is removed from the compressed gas containing water when passing through the through-hole 134 of the hollow fiber membrane 132, and the compressed gas is discharged from the through-hole 134 of the hollow fiber membrane 132 in a dried state.

The removing section 130 does not necessarily use the hollow fiber membrane 132, but may remove water from the compressed gas using another method. For example, the removing section 130 has a centrifugal-type water separator, and removes partial water contained in the compressed gas by centrifuging water contained in the compressed gas.

The decomposing section 140 is provided downstream of the removing section 130 in the line 101. The decomposing section 140 includes the catalyst 141. The catalyst 141 has a carrier with a predetermined structure, and a coating layer supported on the surface of the carrier. For example, the predetermined structure is a honeycomb structure, a corrugated structure, a mesh structure, or a porous structure. For example, the material of the carrier is cordierite, silicon carbide, aluminum titanate, stainless, iron-chromium-aluminum alloy, glass wool, glass fiber, or titanium.

The coating layer purifies methane under an ozone atmosphere. For example, the coating layer includes a zeolite, an iron ion-exchanged zeolite, or a cobalt ion-exchanged zeolite that purifies methane under an ozone atmosphere. Note that the surface area of the carrier may include an area that does not support the coating layer. The coating layer decomposes methane to generate water and carbon dioxide by promoting a reaction between ozone and methane on the surface of the coating layer. When the compressed gas passes through the catalyst 141, methane in the compressed gas is purified, and the compressed gas turns into a purified gas with a smaller amount of methane contained than in the compressed gas.

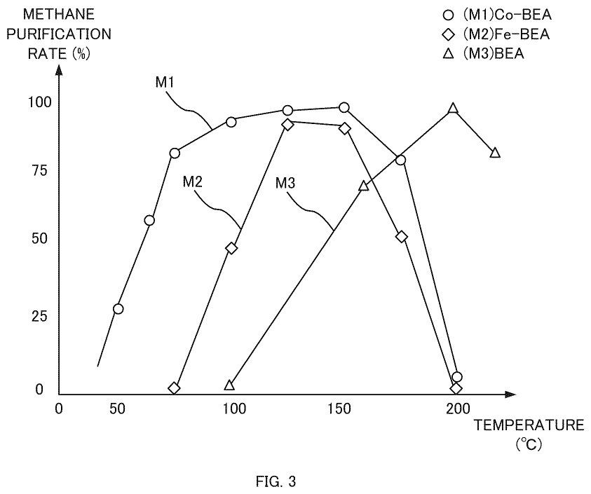

The methane purification rate of the catalyst 141 changes according to the temperature. FIG. 3 is a drawing for explaining the methane purification rate. The horizontal axis of FIG. 3 represents the temperature of the catalyst 141, and the vertical axis of FIG. 3 represents the methane purification rate. The catalyst 141 is heated by the compressed gas. That is, the temperature of the catalyst 141 is equivalent to the temperature of the compressed gas. FIG. 3 depicts a catalyst M1, a catalyst M2, and a catalyst M3 as types of the coating layer of the catalyst 141. The catalyst M1 is a cobalt ion-exchanged zeolite (Co-BEA) in which cobalt is supported on a β-type framework zeolite. The catalyst M2 is an iron ion-exchanged zeolite (Fe-BEA) in which iron is supported on a β-type framework zeolite. The catalyst M3 is a β-type framework zeolite (BEA). As depicted in FIG. 3, in a case where the temperature is lower than 150° C., the methane purification rates of the catalyst M1 and the catalyst M2 increase as the temperature increases. In a case where the temperature is lower than 200° C., the methane purification rate of the catalyst M3 increases as the temperature increases.

The catalyst 141 is heated by heat of the compressed gas. In other words, the purification system S heats the catalyst 141 using heat of the compressed gas to the same temperature as the temperature of the compressed gas. Thereby, the purification system S can heat the catalyst 141 using heat of the compressed gas without heating the catalyst 141 using a heater or the like. Since the temperature of the catalyst 141 rises as a result, the methane purification rate of the catalyst 141 increases.

Meanwhile, in a case where water adheres to the catalyst layer, it becomes difficult for the catalyst 141 to purify methane since the area of contact between methane and ozone on the catalyst layer decreases. In contrast to this, the purification system S removes partial water contained in the to-be-purified gas at the removing section 130. Thereby, it becomes difficult for water to adhere to the catalyst layer. Thereby, the purification system S can prevent the purification of methane from becoming difficult due to water having adhered to the catalyst 141.

The temperature sensor 150 is a sensor that detects the temperature of the compressed gas in the decomposing section 140. The temperature sensor 150 has its leading end inserted into the decomposing section 140, and detects the temperature of the compressed gas in the decomposing section 140. The temperature sensor 150 outputs the detected temperature of the compressed gas to the purification control apparatus 200.

The control valve 160 is provided downstream of the decomposing section 140 in the line 101. The control valve 160 is a valve that can adjust the pressure of the compressed gas in the line 101 by adjusting the amount of the compressed gas that can pass through the control valve 160. As the opening of the control valve 160 increases, the amount of the compressed gas that can pass through the control valve 160 increases. Accordingly, the pressure of the compressed gas lowers as the opening of the control valve 160 increases. As the pressure of the compressed gas lowers, the temperature of the compressed gas in the decomposing section 140 lowers.

As the opening of the control valve 160 decreases, the amount of the compressed gas that can pass through the control valve 160 decreases. Accordingly, the pressure of the compressed gas rises as the opening of the control valve 160 decreases. In this manner, as the pressure of the compressed gas in the decomposing section 140 rises, the temperature of the compressed gas in the decomposing section 140 rises.

Meanwhile, as depicted in FIG. 3, the methane purification rate exhibits a graph which is convex upward. In other words, the methane purification rate becomes equal to or higher than a predetermined value in a case where the temperature of the catalyst 141 falls within a predetermined temperature range, and becomes lower than the predetermined value in a case where the temperature of the catalyst 141 is outside the predetermined temperature range. In one specific example, in a case where the temperature is equal to or higher than 60° C. and equal to or lower than 175° C., the purification rate of the catalyst M1 becomes equal to or higher than 50%. In this manner, the temperature of the catalyst 141 needs to be controlled such that it falls within the predetermined temperature range in order to make the methane purification rate equal to or higher than the predetermined value.

In view of this, the purification control apparatus 200 controls the temperature of the catalyst 141 such that it falls within the predetermined range. Hereinbelow, the configuration of the purification control apparatus 200 is explained. The purification control apparatus 200 has a storage section 210 and a control section 220. The storage section 210 is a storage medium including a ROM (Read Only Memory), a RAM (Random Access Memory), a hard disk, and the like. The storage section 210 stores programs to be executed by the control section 220.

For example, the control section 220 is a computational resource including a processor such as a CPU (Central Processing Unit). By executing programs stored on the storage section 210, the control section 220 realizes functions as an acquiring section 221, a valve control section 222, and a supply control section 223.

The acquiring section 221 acquires the temperature of the catalyst 141. Since the temperature of the catalyst 141 approximately matches the temperature of the compressed gas, the acquiring section 221 may acquire the temperature of the compressed gas sensed by the temperature sensor 150 as the temperature of the catalyst 141. The acquiring section 221 outputs the acquired temperature of the compressed gas to the valve control section 222.

The acquiring section 221 acquires the methane concentration sensed by the methane sensor 102. Each time the methane sensor 102 senses the methane concentration, the acquiring section 221 acquires the methane concentration from the methane sensor 102. The acquiring section 221 outputs the acquired methane concentration to the supply control section 223.

The valve control section 222 can control the temperature of the compressed gas by controlling the opening of the control valve 160. For example, the valve control section 222 adjusts the pressure of the compressed gas, and controls the temperature of the compressed gas by adjusting the opening of the control valve 160. Specifically, the valve control section 222 adjusts the opening of the control valve 160 such that the temperature of the compressed gas becomes equal to or higher than the predetermined temperature, and becomes equal to or lower than the upper limit temperature higher than the predetermined temperature. More specifically, the valve control section 222 adjusts the pressure of the compressed gas such that the temperature of the compressed gas falls within the predetermined temperature range using the following Formula (1) and Formula (2).

$${P}_{0} {V}_{0}^{K} = {P}_{1} {V}_{1}^{K} \qquad ( 1 )$$

$${T}_{0} {V}_{0}^{K - 1} = {T}_{1} {V}_{1}^{K - 1} \qquad ( 2 )$$

P₀ in Formula (1) represents the pressure of the compressed gas before adjustment. P₁ in Formula (1) represents the pressure of the compressed gas after adjustment. V₀ in Formula (1) and Formula (2) represents the volume of the compressed gas before adjustment. V₁ in Formula (1) and Formula (2) represents the volume of the compressed gas after adjustment. To in Formula (2) represents the temperature of the compressed gas before adjustment. To in Formula (2) represents the temperature of the compressed gas after adjustment. K represents the ratio of specific heats. The ratio of specific heats is the ratio of the specific heat capacity at constant pressure to the specific heat capacity at constant volume, and is approximately 1.4 in the case of atmospheric air (air). Note that the volume of the to-be-purified gas in the decomposing section 140 of the present embodiment is constant since it does not change even if the opening of the control valve 160 is adjusted. In a case where the volume of the compressed gas is constant, the temperature and pressure of the compressed gas are proportional to each other.

In a case where the temperature of the compressed gas is lower than the predetermined temperature, the valve control section 222 raises the temperature of the compressed gas by reducing the opening of the control valve 160 to raise the pressure of the compressed gas. The predetermined temperature is a temperature at which the methane purification rate representing the amount of methane that the catalyst 141 can purify becomes equal to or higher than a predetermined value. For example, the predetermined value is 50%, and is desirably 80%. In a case where the catalyst 141 is a cobalt ion-exchanged zeolite, the temperature at which the methane purification rate becomes 50% is 60° C., and the temperature at which the methane purification rate becomes 80% is 75° C. In a case where the temperature of the compressed gas is lower than 60° C., at which the methane purification rate becomes 50%, the valve control section 222 makes the temperature of the compressed gas equal to or higher than 60° C. by making the opening of the control valve 160 smaller than the current opening. Thereby, the valve control section 222 can make the methane purification rate of the catalyst 141 equal to or higher than 50%.

In a case where the temperature of the compressed gas is higher than the upper limit temperature, the valve control section 222 lowers the temperature of the compressed gas by increasing the opening of the control valve 160 to lower the pressure of the compressed gas. The upper limit temperature is a temperature at which the purification rate becomes lower than the predetermined value as the temperature of the catalyst 141 rises. In a case where the catalyst 141 is the catalyst M1 (cobalt ion-exchanged zeolite) in FIG. 3, the temperature at which the methane purification rate becomes 80% as the temperature of the catalyst 141 rises is 160° C., and the temperature at which the methane purification rate becomes 50% as the temperature of the catalyst 141 rises is 175° C. In a case where the temperature of the compressed gas is higher than 175° C., at which the purification rate becomes 50%, the valve control section 222 makes the temperature of the compressed gas equal to or lower than 175° C. by making the opening of the control valve 160 greater than the current opening. Thereby, the valve control section 222 can make the methane purification rate of the catalyst 141 equal to or higher than 50%.

Since the valve control section 222 can adjust the temperature of the compressed gas by adjusting the opening of the control valve 160 in this manner, the valve control section 222 can make the temperature of the compressed gas equal to or higher than the predetermined temperature and equal to or lower than the upper limit temperature. Specifically, in a case where the catalyst 141 is the catalyst M1 (cobalt ion-exchanged zeolite), the valve control section 222 makes the temperature of the compressed gas equal to or higher than 60° C. and equal to or lower than 175° C. Thereby, the valve control section 222 can make the methane purification rate equal to or higher than 50%. By doing so, the valve control section 222 can enhance the methane purification rate as compared to a case where the temperature of the compressed gas is not adjusted.

The valve control section 222 may raise the temperature of the compressed gas in order to remove water having adhered to the catalyst 141. For example, the valve control section 222 makes the temperature of the compressed gas equal to or higher than 80° C. By doing so, the catalyst 141 is heated by heat of the compressed gas, and the temperature of the catalyst 141 rises. Accordingly, it becomes easier for water having adhered to the catalyst 141 to evaporate. That is, the valve control section 222 can remove water having adhered to the catalyst 141 by making the temperature of the compressed gas equal to or higher than 80° C. Accordingly, the valve control section 222 can prevent the methane purification rate from lowering.

The supply control section 223 controls the operation of the compressing section 120 according to the methane concentration of the to-be-purified gas. For example, in a case where the methane concentration of the to-be-purified gas is equal to or higher than the threshold, the supply control section 223 causes the compressing section 120 to draw in the to-be-purified gas. For example, the threshold is a lower limit value at which the methane sensor 102 can sense methane. In a case where the methane concentration is equal to or higher than the threshold, the supply control section 223 increases the amount of the to-be-purified gas to be drawn in per unit time by the compressing section 120 as the methane concentration increases. Specifically, the supply control section 223 increases the amount of the to-be-purified gas to be drawn in by the compressing section 120 by raising the rotation speed of the compressing section 120 as the methane concentration increases. Thereby, the purification system S can purify a larger amount of the to-be-purified gas since a larger amount of the to-be-purified gas is drawn in in a case where the methane concentration is high.

The supply control section 223 supplies ozone to the to-be-purified gas after an operation start of the compressing section 120. For example, in a case where the supply section 110 supplies ozone to the to-be-purified gas by discharge, the supply control section 223 changes the amount of ozone to be supplied to the to-be-purified gas by changing the voltage and/or frequency of an AC voltage that the AC power supply 111 applies to the electrodes 112 of the supply section 110. In one specific example, while the compressing section 120 is in operation, the supply control section 223 increases the amount of ozone to be supplied to the to-be-purified gas by increasing the voltage and/or frequency of an AC voltage that the AC power supply 111 applies to the electrodes 112 of the supply section 110 as the amount of the to-be-purified gas to be drawn in by the compressing section 120 increases. Thereby, the amount of ozone to be supplied is increased as the amount of the to-be-purified gas increases. Accordingly, it becomes easier for ozone and methane to react on the catalyst 141.

In a case where the methane concentration is lower than the threshold, the supply control section 223 does not cause the compressing section 120 to draw in the to-be-purified gas. In other words, the supply control section 223 stops the operation of the compressing section 120. In a case where the compressing section 120 is in an operation stopped state, the supply control section 223 does not supply ozone to the to-be-purified gas. Thereby, the purification system S can reduce energy waste since the compressing section 120 does not draw in the to-be-purified gas, and the supply section 110 does not generate ozone in a case where the amount of methane contained in the to-be-purified gas is so small that the methane sensor 102 cannot sense methane.

### [Methane Purification Process]

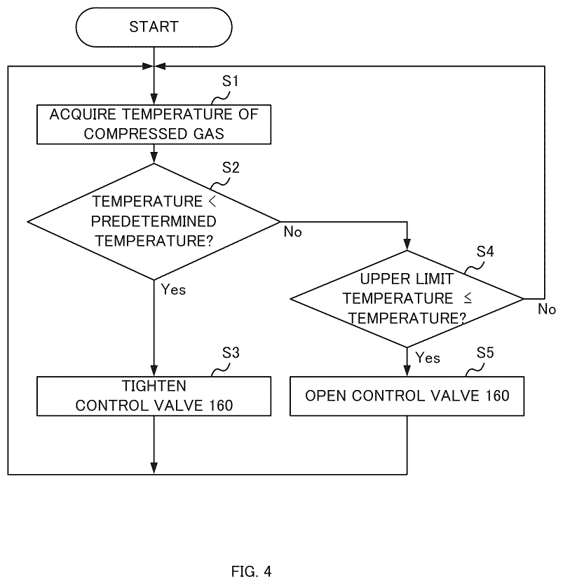

FIG. 4 is a flowchart depicting an example of a methane purification process. The methane purification process is executed after the compressing section 120 has started drawing in the to-be-purified gas, and the supply section 110 has started ozone supply to the to-be-purified gas.

The acquiring section 221 acquires the temperature of the compressed gas (Step S1). For example, the acquiring section 221 acquires the temperature of the compressed gas detected by the temperature sensor 150.

The valve control section 222 determines whether or not the temperature of the compressed gas is lower than the predetermined temperature (Step S2). In a case where the temperature of the compressed gas is lower than the predetermined temperature (Yes at Step S2), the valve control section 222 tightens the control valve 160 (Step S3). Specifically, the valve control section 222 increases the pressure of the compressed gas by tightening the control valve 160 to reduce the opening of the control valve 160. The temperature of the compressed gas rises as the pressure rises. The valve control section 222 raises the temperature of the compressed gas to make the temperature equal to or higher than the predetermined temperature by tightening the control valve 160.

In a case where the temperature of the compressed gas is equal to or higher than the predetermined temperature (No at Step S2), the valve control section 222 determines whether or not the temperature of the compressed gas is equal to or higher than the upper limit temperature (Step S4). In a case where the temperature of the compressed gas is equal to or higher than the upper limit temperature (Yes at Step S4), the valve control section 222 opens the control valve 160 (Step S5). Specifically, the valve control section 222 lowers the pressure of the compressed gas by opening the control valve 160 to increase the opening of the control valve 160. The temperature of the compressed gas lowers as the pressure lowers. The valve control section 222 lowers the temperature of the compressed gas to make the temperature lower than the upper limit temperature by opening the control valve 160. In a case where the temperature of the compressed gas is lower than the upper limit temperature (No at Step S4), the valve control section 222 maintains the opening of the control valve 160, and returns to Step S1.

While the compressing section 120 is in operation, the valve control section 222 repeats the processes from Step S1 to Step S5. In a case where the compressing section 120 has stopped the operation or in a case where an instruction for stopping the methane purification process is accepted, the purification control apparatus 200 ends the methane purification process.

### [Effects of Purification System S]

As explained above, the purification system S has: the supply section 110 that is provided in the line 101 where the to-be-purified gas containing methane and oxygen flows, and supplies ozone to the to-be-purified gas by generating the ozone from oxygen contained in the to-be-purified gas; the compressing section 120 that is provided downstream of the supply section 110, and adiabatically compresses the to-be-purified gas supplied with the ozone; and the catalyst 141 that is provided downstream of the compressing section 120, and purifies the methane in the to-be-purified gas under an ozone atmosphere. Then, the compressing section 120 raises the temperature of the to-be-purified gas by adiabatically compressing the to-be-purified gas.

As described above, the purification system S generates ozone from oxygen contained in the to-be-purified gas at a lower temperature before being adiabatically compressed, adiabatically compresses the to-be-purified gas, and raises the temperature of the to-be-purified gas. Since the generation amount of ozone is greater in a case where ozone is generated from the gas at a lower temperature than in a case where ozone is generated from the gas at a higher temperature, the purification system S can generate a greater amount of ozone than in a case where ozone is generated using compressed air at a higher temperature. Thereby, the purification system S can increase ozone to be brought into contact with the catalyst 141. As a result, the purification system S can enhance the probability that methane and ozone react on the catalyst 141. Accordingly, the purification rate of methane, which is an air pollutant that exhibits greenhouse effect properties, can be enhanced.

Whereas the present invention has been explained using embodiments thus far, the technical scope of the present invention is not limited by the scope described in the embodiments described above, but various modifications and changes are possible within the scope of a gist of the present invention. For example, all or some of apparatuses can be configured functionally or physically distributed or integrated in any units. In addition, new embodiments that are generated by any combination of a plurality of embodiments are also included in embodiments of the present invention. Effects of the new embodiments generated by the combination combine effects of the original embodiments.

1. A purification system comprising:
a supply section that is provided in a line where a gas containing methane and oxygen flows, and supplies ozone to the gas by generating the ozone from the oxygen contained in the gas;
a compressing section that is provided downstream of the supply section in the line, and adiabatically compresses the gas supplied with the ozone; and
a catalyst that is provided downstream of the compressing section in the line, and purifies the methane in the gas under an ozone atmosphere, wherein
the compressing section raises temperature of the gas by adiabatically compressing the gas.

2. The purification system according to claim 1, comprising:
a control valve that is provided downstream of the catalyst in the line, and can adjust pressure of the gas in the line; and
a valve control section that can adjust the pressure of the gas, and control the temperature of the gas after having passed through the compressing section by adjusting opening of the control valve, wherein
the valve control section adjusts the opening of the control valve such that the temperature of the gas becomes equal to or higher than a predetermined temperature, and equal to or lower than an upper limit temperature higher than the predetermined temperature.

3. The purification system according to claim 2, wherein the predetermined temperature is a temperature at which a purification rate representing an amount of the methane that the catalyst can purify becomes equal to or higher than a predetermined value.

4. The purification system according to claim 2, wherein, in a case where the temperature of the compressed gas is equal to or lower than the predetermined temperature, the valve control section raises the temperature of the gas by reducing the opening of the control valve to raise the pressure of the gas.

5. The purification system according to claim 2, wherein, in a case where the temperature of the compressed gas is higher than the upper limit temperature, the valve control section lowers the temperature of the gas by increasing the opening of the control valve to lower the pressure of the gas.

6. The purification system according to claim 5, wherein the compressing section increases an amount of the gas to be drawn in per unit time as concentration of the methane in the gas increases.

7. The purification system according to claim 1, comprising a removing section that is provided between the compressing section and the catalyst in the line, and removes at least partial water of water included in the adiabatically compressed gas.

8. The purification system according to claim 7, wherein the removing section has a hollow fiber membrane through which water can be transmitted, and discharges the partial water to outside of the hollow fiber membrane when the gas whose pressure has become higher than pressure of a gas outside the hollow fiber membrane by being compressed by the compressing section flows inside the hollow fiber membrane.

9. The purification system according to claim 1, comprising a supply control section that stops an operation of the compressing section in a case where concentration of the methane in the gas is lower than a lower limit value at which a methane sensor that senses the concentration of the methane can sense the methane.

10. The purification system according to claim 9, wherein
the supply control section
causes the compressing section to start drawing in the gas in a case where the concentration of the methane is equal to or higher than the lower limit value; and
controls the supply section to supply the ozone to the gas after the compressing section has started drawing in the gas.

11. The purification system according to claim 9, wherein the supply control section increases an amount of the ozone to be supplied to the gas as an amount of the gas to be drawn in by the compressing section increases.
